(19) United States
(12) Patent Application Publication
(10) Pub. No.: US 2014/0118799 A1
(43) Pub. Date: May 1, 2014

(54) PORTABLE MAGNIFYING CAMERA

(71) Applicant: Ronald Patrick Jacob Qurinus Van Der Snoek, Dirksland (NL)

(72) Inventor: Ronald Patrick Jacob Qurinus Van Der Snoek, Dirksland (NL)

(73) Assignee: Optelec Development B.V., Barendrecht (NL)

(21) Appl. No.: 14/114,437

(22) PCT Filed: Apr. 27, 2012
(86) PCT No.: PCT/NL2012/050296

§ 371 Date: Dec. 17, 2013

(30) Foreign Application Priority Data
Apr. 29, 2011 (NL) 2006698

(51) Int. Cl. H04N 1/195

(52) U.S. Cl. CPC H04N 1/19594
USPC 358/473

(57) ABSTRACT

A portable camera for recording and displaying an image of an object such as printed paper wherein the camera is arranged to be positioned on an object to be recorded wherein the cameras is provided with an outer lower surface which is arranged to be in contact with the object if the camera is positioned on the object, a light sensitive sensor for obtaining an image of at least a portion of the object, a display and processing means for processing the image obtained by means of the sensor and for displaying at least a portion of the recorded image on the display in a possible magnified form, wherein the camera is provided with at least one lighting unit for lighting the object to be recorded when the camera is positioned on the object, wherein the camera is arranged such that light rays of the at least one lighting unit which are, in use, submitted to the object are directly submitted to the object, possibly via a mirror and/or a lens wherein the lighting unit is arranged within the camera such that if the object which is recorded would be a flat mirror whereon the camera is positioned for recording the flat mirror, the lighting unit is located outside a viewing field of the sensor which viewing field is formed in combination with the flat mirror.

The invention relates to a portable magnifying camera for the visual disabled person. More particularly, the invention relates to a portable camera for recording and displaying an image of an object such as printed paper, wherein the camera is arranged to be positioned on an object to be recorded wherein the cameras is provided with an outer lower surface which is arranged and intended to be in contact with the object if the camera is positioned on the object, a light sensitive sensor for obtaining an image of at least a portion of the object, a display and processing means for processing the image obtained by means of the sensor and for displaying at least a portion of the recorded image on the display, in possible a magnified form, wherein the camera is provided with at least one lighting unit for lighting the object to be recorded when the camera is positioned on the object.

Such a camera is generally known. The object to be recorded is for example a newspaper which lies on the table. In such a camera, lighting is very important. Important parameters are glare, shadow and gradient on a surface of the object to be recorded. For bigger machines it is possible to place and design the lighting unit in such a way that the intensity of the light is spread evenly over a surface to be recorded. When designing compact magnifiers, the lighting is always a problem because the proximity of the lighting unit causes light spots on the object to be recorded as well as glare. Thus a problem is that light which is emitted by the lighting unit is reflected by a glossy surface to be recorded by the camera towards the sensor so that the sensor can “see” the lighting unit as an image. In the past this has been solved by using indirect or concealed lighting causing a more uniform incidence. In practice this means diffuse reflection: the lighting unit shines on a frosted white surface and then reflects on the object to be recorded. Another well-known solution is adding a diffuser in between the object to be recorded and the lighting unit. This will result in a diffuse light source which will minimize shadow and light spots, thus resulting in an evenly illuminated object to be recorded. A draw-back in this design is however a lot of loss of efficiency. This is caused by the fact that the light is partly blocked by the diffuser. Another draw-back is that the light diffuse surface (reflector or translucent) will act as a new light source although bigger and spreading “softer” light. The proximity problem (glare) in compact design however remains, now with a bigger surface of light. Therefore, on reflective objects to be recorded, like glossy paper, the diffuser will still be reflected as an outline of surface that is overexposed on the object area. This will have an impact on black and white tones on the object. This again will result in problems when enhancing the image in high contrast pictures, for example, when the image is translated in black and white only. The overexposed area will be translated in white, masking the more subtle grey tones “underneath”. A bigger diffusion (for example twice as big as the object area) to prevent this phenomenon is not a solution, because such a diffuser would be too big for a portable camera.

It is an object of the invention to provide a solution to at least one of the above referred to draw-backs.

According to the invention, the camera is arranged such that light rays of the at least one lighting unit which are, in use, submitted to the object are directly submitted to the object, possibly via a mirror and/or a lens, wherein the lighting unit is arranged within the camera on a position relative to the sensor such that if the object which is recorded would be a flat mirror whereon the camera is positioned for recording the reflective surface of the flat mirror (so that the reflective surface of the flat mirror faces the sensor), the lighting unit is located outside a viewing field of the sensor which viewing field is formed in combination with the flat mirror. It further holds that the flat mirror is sufficiently large so that it extends through the full viewing field of the sensor. This means that the full viewing field is mirrored by the flat mirror for defining the position of the lighting unit relative to the sensor. Because the light source is placed in an area where the sensor cannot see it, the problem of glare cannot occur. Also a more even distribution of light on the object can be realized. Of course the mirror itself does not belong to the camera. The mirror is merely used for defining the position of the lighting unit relative to the sensor wherein this position is independent from the presence or absence of the mirror. In other words, because the light source is placed in an area where the sensor cannot see it if the mirror would be present, the problem of glare cannot occur if other objects having a (somewhat) reflective surface are recorded. Alternatively according to the invention the camera is arranged such that light rays of the at least one lighting unit which are, in use, submitted to the object are directly submitted to the object, possibly via a mirror and/or a lens, wherein the lighting unit is arranged within the camera on a position relative to the sensor such that the lighting unit is located outside a viewing field of the sensor which viewing field would be formed in combination with a virtual flat mirror extending in a virtual flat plane extending through the lower outer surface wherein a reflective surface of the mirror faces the sensor. Again it further holds that the virtual flat mirror is sufficiently large so that it extends through the full viewing field of the sensor. This means that the full viewing field is mirrored by the flat mirror for defining the position of the lighting unit relative to the sensor. Because the light source is placed in an area where the sensor cannot see it, the problem of glare cannot occur. Also a more even distribution of light on the object can be realized. Preferably, the camera is provided with at least one light mirror for folding up the light path which extends from the at least one lighting unit to the flat mirror. Because the light path may be folded up, the optical distance between the lighting unit and the object to be recorded can be made bigger without having a negative impact on the size of the portable magnifying camera as such. Such a relatively bigger optical distance between the light and the object, will result in the black and white tones to be eliminated more evenly relative to the situation when there is a relative small optical distance between the lighting unit and the object.

Preferably, it holds that the sensor is provided with an optical axis wherein, in use, the at least one lighting unit is positioned within a lighting unit plane which is perpendicular to the optical axes wherein the lighting unit plane lies between the sensor and a virtual flat plane through which the lower outer surface extends. In this way the portable magnifying camera can be made of a compact design.

According to a preferred embodiment it holds that the camera is provided with a first body portion, a second body portion and a hinge means for connecting the first body portion and the second body portion together wherein the first body portion can move relative to the second body between a folded condition and an unfolded working condition for use of the camera, wherein the second body portion is provided with the sensor and the first body portion is provided with the lighting unit and wherein in the working condition there is a distance between the first body portion and second body portion. In this way the camera can be positioned in a folded condition so that it becomes relatively compact and can be carried easily by the visually handicapped person. For example, the camera may have such a size that it can be positioned in a pocket of a jacket or trousers.

Preferably it holds that the first body portion is arranged to be positioned on the object to be recorded. In that case the first body portion may comprise the outer lower surface. The lighting unit may be arranged to submit light in a direction of the second body portion if the camera is in the folded condition. Preferably, it holds that if the camera is in the unfolded condition, in use, the second body portion extends above the first body portion. In that manner, the portable magnifying camera can be easily positioned on a flat surface which is, for example, provided with a paper to be recorded. Preferably it holds that the real mirror is formed by an outer surface of the second body portion wherein, if the camera is in the unfolded condition, in use, the mirror faces downwardly. Preferably it holds that the second body portion is provided with a display, wherein the display and the mirror lie on opposite sides of the second body part. Preferably it holds that if the camera is in the folded condition, the mirror lies against a surface of the first body part which surface lies opposite the surface of the first body part which forms said outer lower surface.

As indicated above light rays of the lighting unit are transmitted directly to the object, possibly via a mirror and/or a lens. Hence direct transmission of these light rays means that these light rays are not diffused by reflection on, for example, a frosted wall and/or are not diffused by transmission through, for example, a diffuser. Transmission of the light rays through a lens (which provides specular transmission, e.g. conversion and/or diversion of the light beams) or reflection of the light rays on a mirror (which provides specular reflection of the light beams) is however considered as direct transmission of the light rays. In other words: the above mentioned light rays of the lighting unit may be transmitted directly to the object wherein it is also possible that the above mentioned light rays are transmitted to the object via at least one mirror and/or via at least one lens.

It is another object of the invention to provide a portable camera which may be used for different purposes. The portable camera according to this aspect of the invention is characterized in that, the camera is provided with a first body portion, a second body portion and a means for connecting and disconnecting the first body portion and the second body portion, wherein the second body portion is provided with the lighting unit, the sensor and the display and wherein the first body portion is arranged to be positioned on the object to be recorded while the second body portion is connected with the first body portion such that, in use, the first body portion provides a fixed distance between the second body portion and the object to be recorded wherein the first body portion is provided with a side wall surrounding an inner space of the first body portion and a first and second opening lying opposite to each other and each providing visible access to the inner space (if the first body portion and the second body portion are disconnected from each other) wherein if the first body portion and the second body portion are connected together the second opening faces the second body portion and the first opening, in use, faces the object to be recorded such that the sensor can capture an image of the object to be recorded via the second opening, the space and the first opening. Because the first body portion can be disconnected from the second body portion the second body portion can also be used for recording and displaying, for example, an environment of the user or another object if the second body portion is separated from the first body portion. In that mode of use the second body portion need not to be positioned on the object but may simply be hand-held. Because the second body portion is provided with the lighting unit an object or environment to be recorded and displayed by means of the second body portion only, can also be enlightened. It is noted that the portable camera according to this aspect of the invention may, but need not, be also characterized in that the camera is arranged such that light rays of the at least one lighting unit which are, in use, submitted to the object are directly submitted to the object, possibly via a mirror and/or a lens, wherein the lighting unit is arranged within the camera such that if the object which is recorded would be a flat mirror whereon the camera is positioned for recording the reflective surface of the flat mirror, the lighting unit is located outside a viewing field of the sensor which viewing field is formed in combination with the flat mirror.

According to a preferred embodiment the first body portion comprises the outer lower surface. In that case the outer lower surface may comprise the first opening. Preferably the display is inclined relative to the outer lower surface if the second body portion is connected with the first body portion. This provides an easy use if the outer lower portion is positioned on a horizontal surface of an object to be recorded and displayed. According to a special embodiment it holds that if the first body portion is connected to the second body portion a distance between the lighting unit and the outer lower surface is smaller than a distance between the sensor and the outer lower surface. The advantage of the relatively large distance between the sensor and the outer lower surface is that a relative large area of the object can be recorded. The advantage of the relatively small distance between the lighting unit and the outer lower surface is that the object can be lighted efficiently. Preferably the second body portion is provided with a first and second side extending substantially parallel to each other wherein the second side comprises the display and the first side faces the first body portion if the first body portion is connected to the second body portion and/or in that the second body portion has an overall shape of a flat rectangular plate. This enables an easy use of the second body portion if the second body portion is disconnected from the first body portion. Preferably it holds that, the first body portion is provided with a first and second side extending at an angle relative to each other wherein the first side comprises the first opening and the second side comprises the second opening wherein the first side of the second body portion faces the second side of the first body portion if the first body portion is connected to the second body portion. This particular shape of the first body portion provides several advantages: it enables an easy way for the display to be angled relative to the outer lower surface while at the same time the second body portion may have the preferred shape as discussed above. Also the preferred positions of the sensor and the lighting unit relative to the outer lower surface as discussed above can be realised in an easy manner.

According to a advantageous embodiment it further holds that a portion of an inner surface of the first body portion is curved such that, in use, it reflects some of the light emitted by the lighting unit towards the first opening if the first body portion is connected to the second body portion. In this way a more even light distribution over the first opening of the light emitted by the lighting unit can be obtained. This light distribution is at least substantially the sum of the light which is submitted directly from the lighting unit to the first opening and the portion of the light which is reflected by the portion of the curved inner surface towards the first opening. In this respect it preferably holds that the portion of the inner surface is arranged such that the portion of the light emitted by the lighting unit which is reflected by the portion of the inner surface is reflected towards an area of the first opening having a larger distance to the lighting unit than other areas of the first opening, more particularly in that the portion of the inner surface is arranged such that the portion of the light emitted by the lighting unit which is reflected by the portion of the inner surface is reflected towards an area of the first opening having a larger distance to the lighting unit than each other areas of the first opening wherein in particular the area of the first opening having a larger distance to the lighting unit than other areas forms a first halve of the first opening and the other areas form a second halve of the first opening wherein the first halve and the second halve in combination form the first opening. The mentioned areas of the first opening may lie in a virtual plane coinciding with the outer lower surface. Also it may hold that the light rays emitted by the lighting unit which directly illuminates a plane laying in the first opening provide a first distribution of light intensity (for example measured in Lux) in the plane which is not uniform spread over this plane wherein the portion of the inner surface is arranged such that the portion of the light emitted by the lighting unit which is reflected by the portion of the inner surface provides in combination with the light rays which are directly received in the plane a total distribution of light intensity (for example measured in Lux) in the plane which is more uniform spread over this plane than the first distribution. The plane may coincide with the outer lower surface.

Also it may hold that the first opening is provided with a first edge and a second edge laying opposite to each other wherein the lighting unit directly illuminates a plane through the first opening adjacent the first edge with an intensity (for example measured in Lux) which is higher than the intensity by which the plane adjacent the second edge is directly illuminated by the lighting unit and wherein the portion of the inner surface is arranged such that the portion of the light emitted by the lighting unit which is reflected by the portion of the inner surface illuminates the plane adjacent the first edge with an intensity which is lower (including zero intensity) than the intensity by which the plane is illuminated adjacent the second edge by the lighting unit via the portion of the inner surface. Again the plane mat coincide with the outer lower surface. It may also hold that the portion of the inner surface is arranged such that the portion of the light emitted by the lighting unit which is reflected by the portion of the inner surface has a larger intensity on a position laying in the first opening having a larger distance to the lighting unit than other positions laying in the first opening. This intensity may be defined as the intensity of the light at such a position laying in a plane which coincides with the outer lower surface. It may also hold that the portion of the inner surface is arranged such that the portion of the light emitted by the lighting unit which is reflected by the portion of the inner surface increases the intensity of the light more in a first area of the first opening than in a second area of the first opening wherein the intensity of the light in the first area as a result of the light which is directly received from the lighting unit in the first area is lower than the intensity of the light in the second area as a result of the light which is directly received from the lighting unit in the second area, wherein in particular the first area and the second are each form a halve of the first opening and wherein the first area and the second area in combination form the first opening. It may hold that the first area and the second area lay in a plane coinciding with the lower outer surface.

The invention will now be clarified on the basis of the drawing wherein:

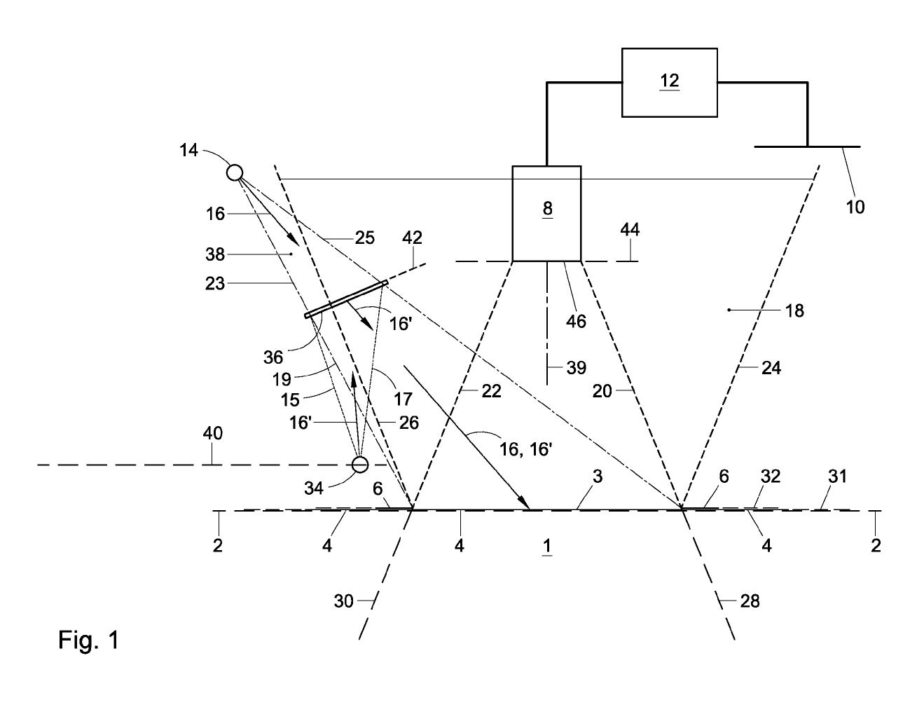

FIG. 1 shows a schematic view of a possible embodiment of a portable magnifying camera according to the invention;

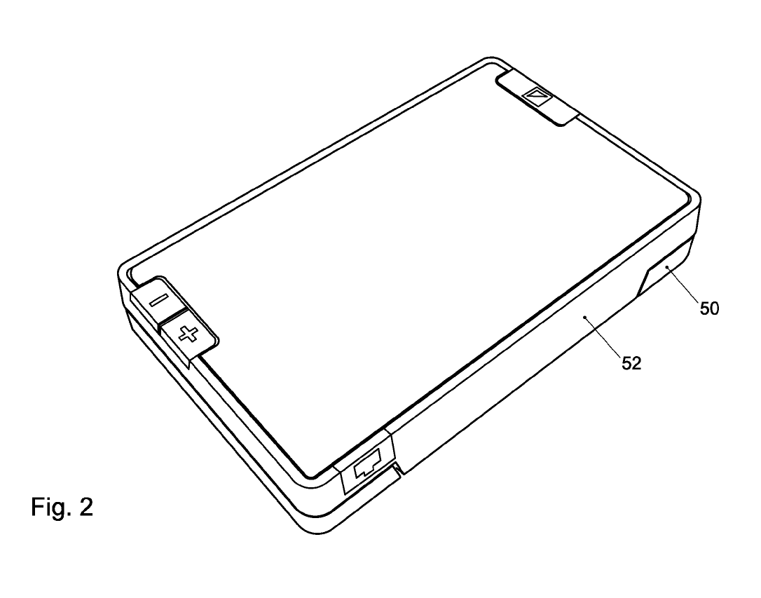

FIG. 2 shows a practical embodiment of a portable magnifying camera according to the principle of FIG. 1;

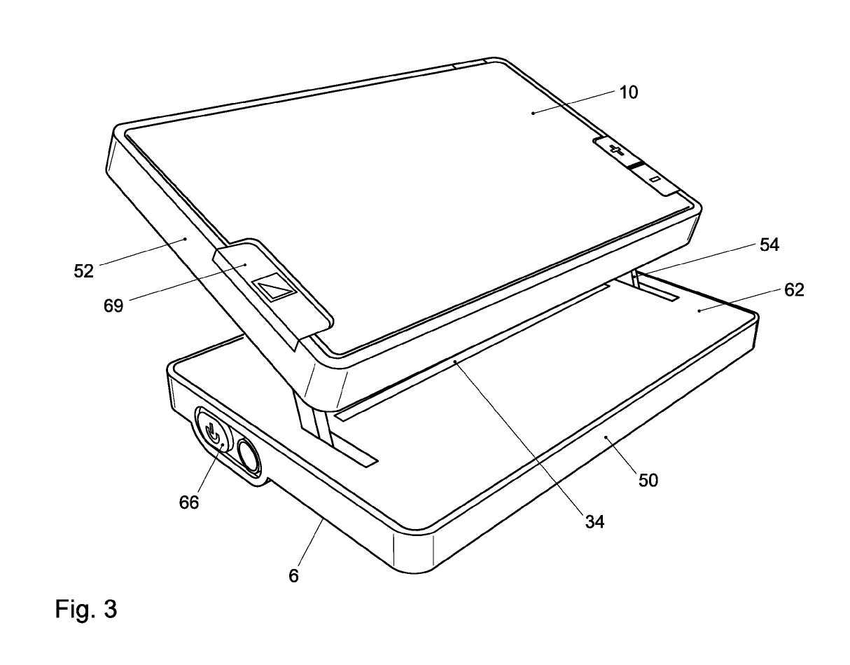

FIG. 3 shows the portable magnifying camera of FIG. 2 in the unfolded condition from a first point of view; and

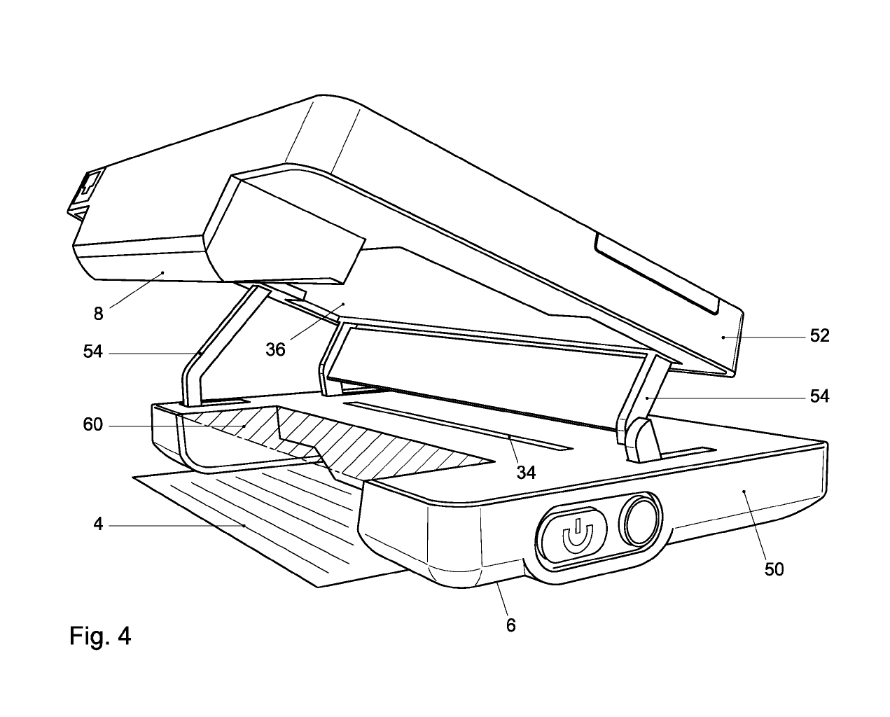

FIG. 4 shows the portable magnifying camera of FIG. 2 in the unfolded condition from a second point of view.

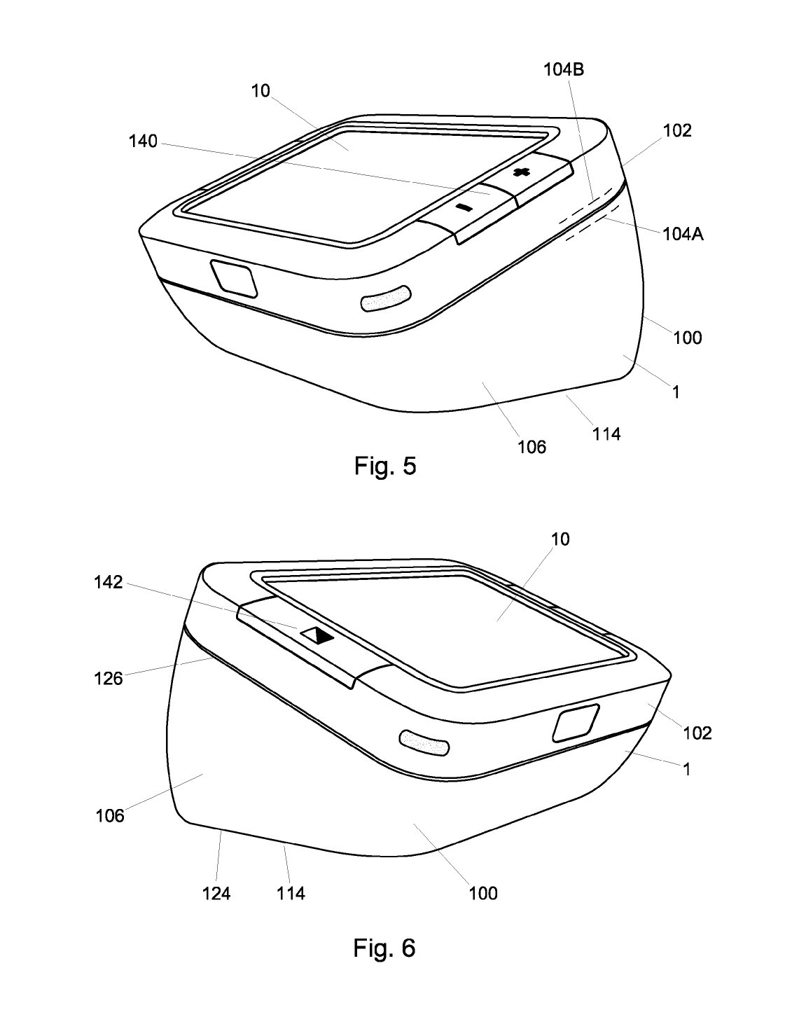

FIG. 5 shows a first view of an alternative embodiment of a camera according to the invention;

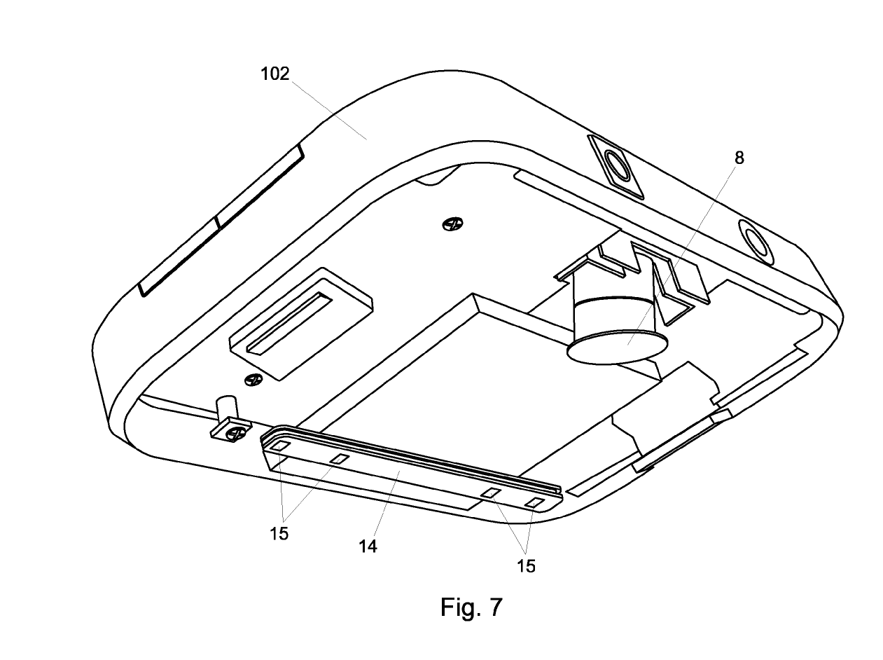

FIG. 6 shows a second view of the camera according to FIG. 5.

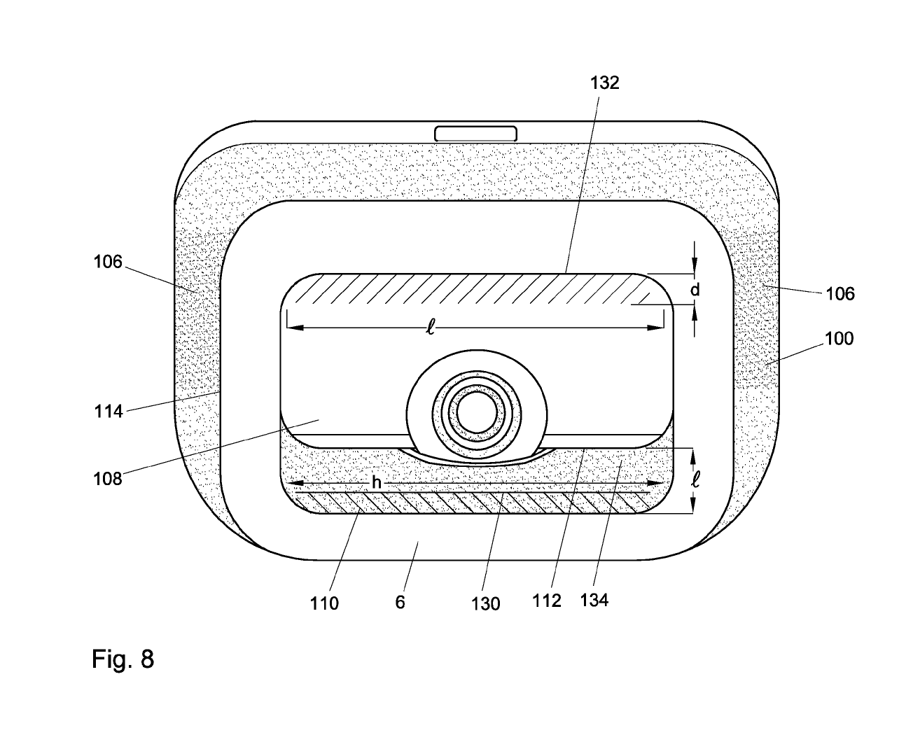

FIG. 7 shows a view of the second body portion of the camera according to FIG. 5;

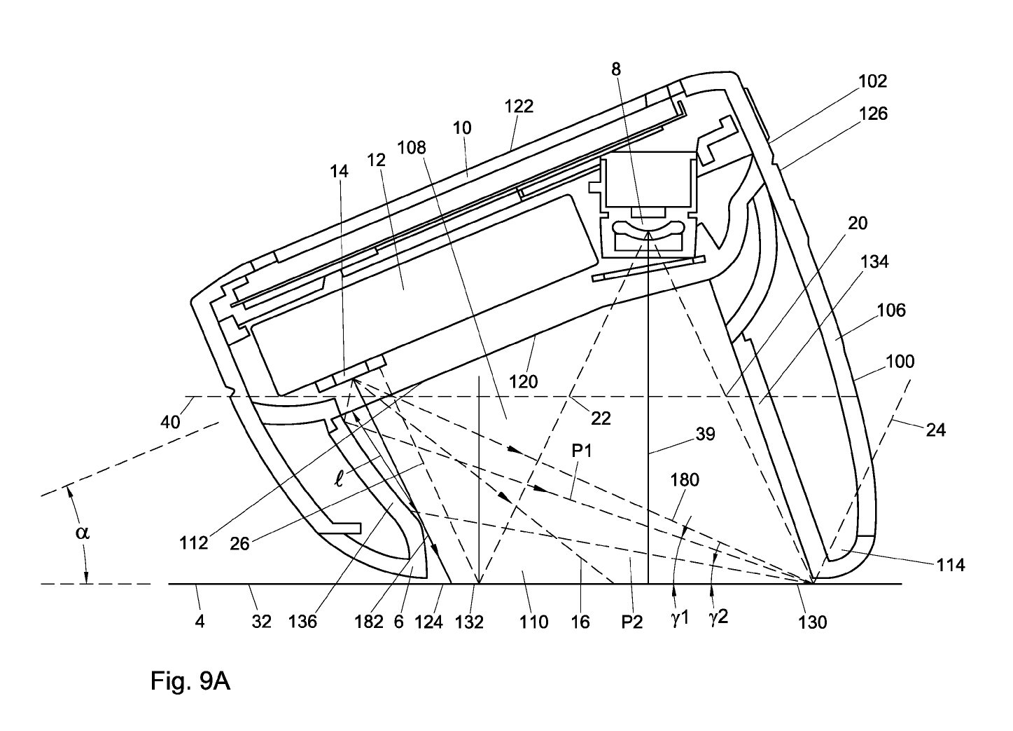

FIG. 8 show a bottom view of the camera according to FIG. 5.

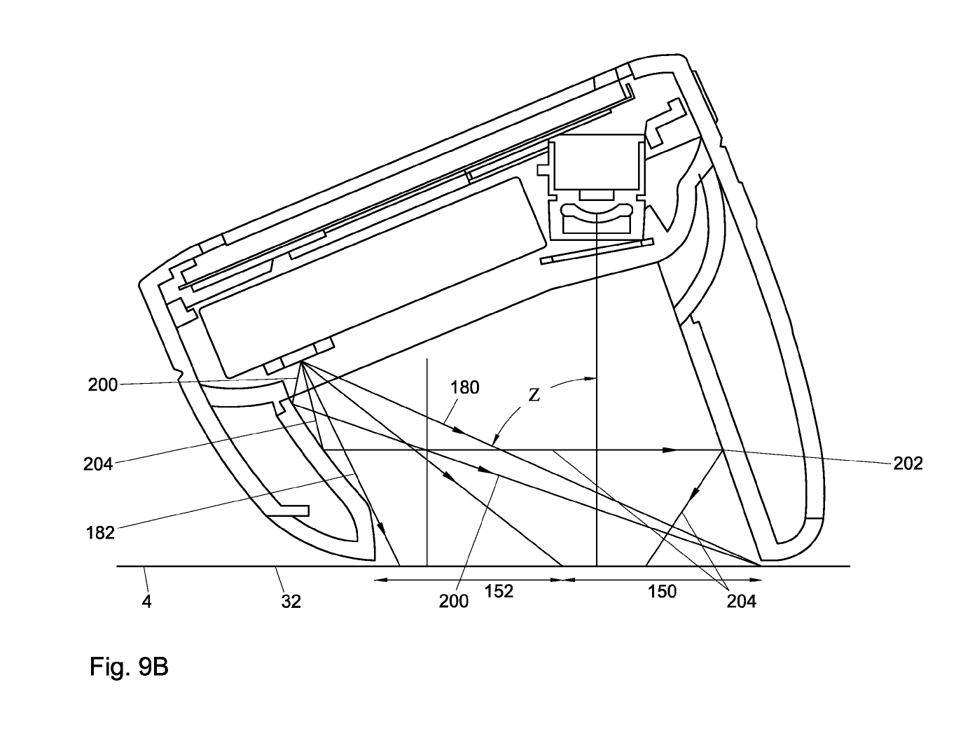

FIG. 9A shows a cross section of the camera of FIG. 5;

FIG. 9B shows a cross section of the camera of FIG. 5

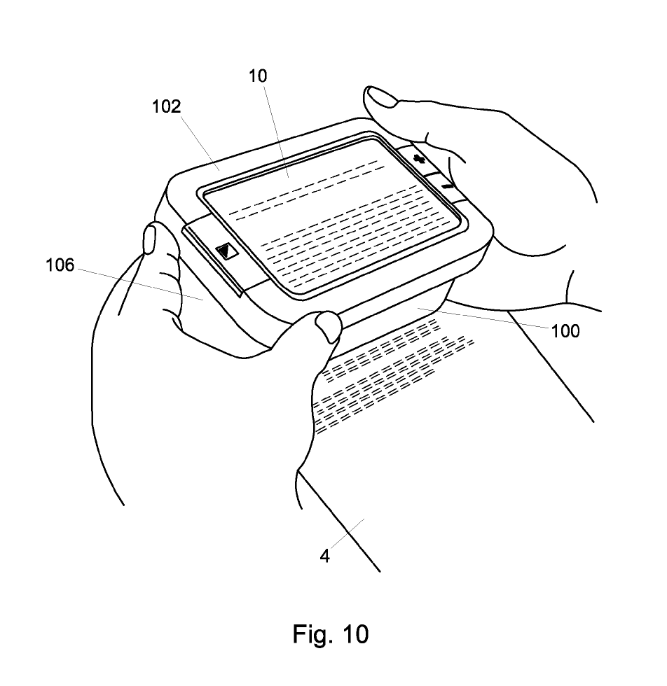

FIG. 10 shows a possible use of the camera according to FIG. 5; and

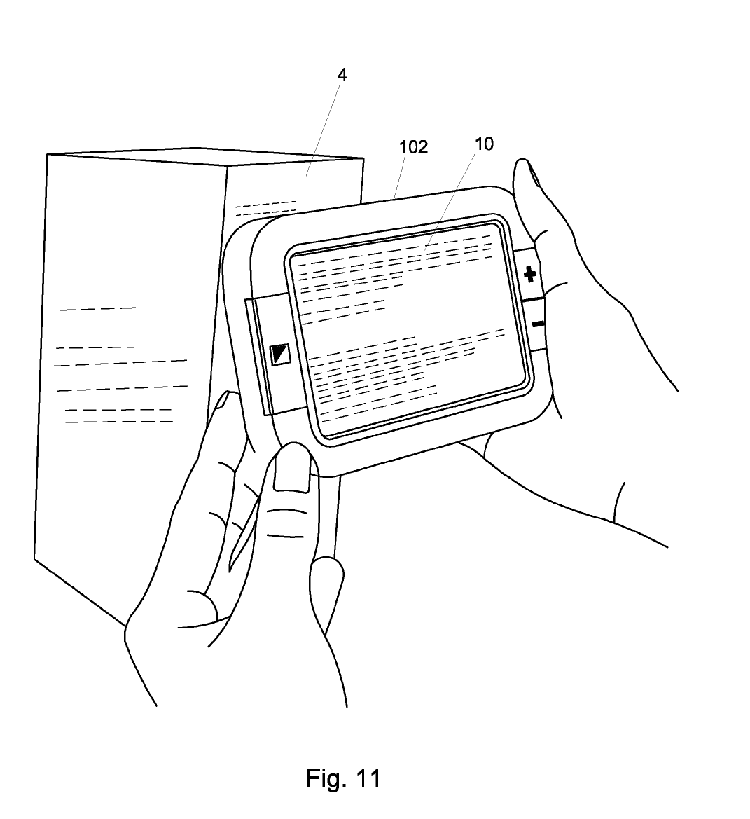

FIG. 11 shows a possible use of the second body portion of the camera according to FIG. 5.

In FIG. 1 a portable magnifying camera is referred to by means of reference number 1. The camera is for recording and displaying an image of an object such as printed paper lying on a surface of a table. In FIG. 1 the surface of the table is referred to by reference number 2. On this table 2, an object to be recorded is provided with reference number 4. As is shown in FIG. 1 the camera is positioned on the object 4 to be recorded. The camera is provided with an outer surface 6 which is arranged to be in contact with the object 4 if the camera is positioned on the object 4. The camera is further provided with a light sensitive sensor 8 for obtaining an image of at least a portion of the object 4. The light sensitive sensor 8 is, for example, a CCD or CMOS. Other types of sensors are however also possible.

Furthermore, the camera is provided with a display 10 and processing means 12 for processing the image obtained by means of the sensor 8 and for displaying at least a portion of the recorded image on the display 10 in a possible magnified form. The camera is further provided with at least one lighting unit 14 for lighting the object 4 to be recorded when the camera is positioned on the object. The lighting unit 14 may for example be formed by well-known led's.

According to the invention the lighting unit is located on a special position. As can be seen in FIG. 1, the lighting unit is positioned such that light rays 16 of the lighting unit which are submitted to the object 4 are directly submitted to the object. Furthermore, the lighting unit is arranged within the camera such that if the object 4 which is recorded, would be a flat mirror 4 whereon the camera is positioned for recording the reflective surface 3 of the flat mirror 4, the lighting unit is located outside a viewing field 18 of the sensor which the viewing field is formed in combination with the flat mirror 4. This means that the reflective surface 3 of the flat mirror faces the sensor 8. It also means that the sensor can not ‘see’ the lighting unit via the flat mirror. The outer boundaries of the viewing field 18 are indicated by dotted lines 20, 22, 24, 26. The flat mirror is sufficiently large so that it extends through the full viewing field of the sensor. Indeed the flat mirror is sufficiently large so that it does not limit the size of the viewing field extending away from the reflective surface of the flat mirror (the portion of the viewing field which extends away from the reflective surface of the mirror extends between the dotted lines 24 and 26 and is not limited by a size of the flat mirror because the flat mirror extends through the full viewing field. This also means that the full viewing field is mirrored by the flat mirror for defining the position of the lighting unit relative to the sensor.). In fact the viewing field which extends between the dotted lines 20 and 22 is within the viewing field which extends between the lines 24 and 26. The viewing field which would extend in FIG. 1 below the flat mirror 4 if this mirror would be deleted, is indicated by dotted lines 28, 30, which dotted lines again show the outer boundaries of this portion of the viewing field. The resulting viewing field which boundaries are formed by the dotted lines 20, 22, 28, 30 has the form of a cone. These dotted lines 20, 22, 28, 30 form the outer boundaries of the viewing field without the object 4. However due to the object 4 in the form of the mirror 4 the portion of the viewing field which is bounded by the dotted lines 28, 20 is mirrored in a flat plane 31 which extends through the flat mirror 4. The actual viewing field which is reflected in the flat mirror 4 and which lies within the dotted lines 24, 26, forms a portion of the cone.

As becomes clear from FIG. 1, the lighting unit is arranged within the camera such that the lighting unit is located outside the viewing field of the sensor 8. The advantage is that if the object 4 would, for example, be printed paper which at least slightly reflects light by means of specular reflection, the image of such object will not be glared by the lighting unit 14. The sensor 8 can not ‘see’ the lighting unit 14 via a reflective surface of the object (independent from the size of the reflective surface) which reflective surface would face the sensor 8. This holds for each size of the reflective surface of the object because the above mentioned flat mirror which was used for defining the position of the lighting unit within the camera extends through the full viewing field of the sensor.

On the other hand the light emitted by the lighting unit will lighten directly the object.

As becomes clear from FIG. 2, the outer lower surface 6 extends in a virtual flat plane 32 wherein, in use, the lighting unit submits light to the virtual flat plane 32. Also it holds that the flat mirror 4 lies against the virtual flat plane 32. In fact for determining the viewing angle it is assumed that the flat plane 32 coincides with the flat plane 31 now these planes lie against each other (for clarity reasons in FIG. 1 there is shown a schematic small distance between plane 31 and plane 32). This means that it also holds that the lighting unit is located outside a viewing field of the sensor which viewing field is formed in combination with the virtual flat plane 32 if the virtual flat plane would be a flat mirror.

The camera is arranged such that the light rays of the lighting unit 14 are submitted directly to the object. If there would be any reflection of the light that reaches the object 4 it would be specular reflection only.

In accordance with a preferred embodiment the lighting unit 14 is replaced by a lighting unit 34. Furthermore, in that preferred embodiment the camera is provided with a light mirror 36 for folding up the possible light paths 38 which extends from the at least one lighting unit 34 to the flat mirror 4 (the outer boundaries of the area wherein such folded up light paths extend are indicated by dotted lines 15, 17, 19, 21 and the outer boundaries of the light paths without the light mirror 36 are indicated by dotted lines 23, 25, 19, 21). The light mirror 36 provides specular reflection of the light emitted by the lighting unit that reaches the object. As can be understood from FIG. 1, the lighting unit 34 is positioned in such a manner relative to the mirror 36 that light 16′ which is submitted by the lighting unit 34, reaches the object 4 as if the lighting unit 34 would be positioned on a position where the lighting unit 14 is positioned when the mirror 36 is not present. A light path which extends from the lighting unit 34 to the object 4 is indicated by a light ray 16′. Because of the position of the lighting unit 34, the camera can be of a more compact design compared with the situation wherein the lighting unit 14 is present. Moreover, the length of the light path 16′ will result in a more even light distribution over the object. Again it holds that the lighting unit directly submits light (via the light mirror 36) to the object 4. It this case the light is also reflected, but this reflection is specular reflection only.

The sensor 8 is provided with an optical axis 39. The optical axis 39 is the actual axis of the viewing field of the sensor 8 which has the shape of a cone.

As can be seen from FIG. 1, the lighting unit 34 is positioned within a lighting unit plane 40 which is perpendicular to the optical axis 39. The lighting unit plane 40 lies between the sensor 8 and the virtual flat plane 32. It follows also from the above that the light rays 16′ of the lighting unit 34 are submitted to the flat mirror 4 by means of specular reflection only.

It follows also from FIG. 1 that the mirror lies in a mirror plane 42 which is angled relative to the lighting unit plane 40.

It follows also that the mirror 36 lies between the lighting unit plane 40 and a sensor plane 44 extending through an outer surface 46 of the sensor 8 which outer surface 46 receives the light for recording. The sensor plane 44 is perpendicular to the optical axis 39. In FIG. 1 only one lighting unit 34 is provided which submits light via the mirror 36 to the object 4. It is however also possible that additional light sources and/or additional mirrors are provided for submitting light to the object 4 to be recorded wherein such additional lighting units are positioned outside the viewing angle of the sensor 8. It is also possible that the lighting unit submits light directly to the object 4 via additional lenses.

In FIGS. 2-4 a practical embodiment of a portable magnifying camera 1′ is provided working according to the same principal as discussed for FIG. 1. In FIGS. 2-4 and FIG. 1, features which correspond with each other are provided with the same reference numbers.

The portable magnifying camera is provided with a first body portion 50, a second body portion 52, and hinge means 54 for connecting the first body portion and the second body portion together. The first body portion can be moved relative to the second body portion between a folded condition as is shown in FIG. 2 and an unfolded working condition as is shown in FIGS. 3 and 4. The unfolded working condition as shown in FIGS. 3 and 4 is the condition for use of the camera. The second body portion 52 is provided with the sensor 8. The first body portion is provided with the lighting unit 34 which in this example is formed by a longitudinal array of LED's. In the working condition there is a distance between the first body portion 50 and the second body portion 52. The first body portion is arranged to be positioned on the object 4 to be recorded. The object 4 can for example be a piece of paper lying on a table. The first body portion 50 comprises the outer lower surface 6 as can be seen in FIG. 4. If the camera is in the unfolded condition, in use, the second body portion extends above the first body portion. The light mirror 36 is formed by an outer surface of the second body portion. If the camera is in the unfolded condition, the light mirror 36 faces downwardly as will be clear from FIG. 4. The lighting unit 34 is arranged to submit light in a direction of the second body portion if the camera is in the unfolded condition. This light is reflected by the light mirror 36 and submitted to the object which is schematically shown in FIG. 4 by a plurality of lines. The second body portion is further provided with the display 10. The display and the mirror lie in opposite sides of the second body portion 52.

Furthermore, the processing means 12 can be arranged in the first body portion 50 and/or the second body portion 52. As becomes clear from FIGS. 3 and 4, the first body portion and the second body portion each have an overall shape of a flat rectangular plate. The first body portion has the same overall shape and size as the second body portion. Furthermore, the first body portion is provided with an opening 60 for recording the object 4. Basically the opening 60 provides that the first body portion 50 has somewhat the shape of a U. The opening 60 is indicated by a plurality of lines.

The position of the sensor 8, the mirror 36, the lighting unit 34, and the outer surface 6 in working condition of the practical embodiment as shown in FIGS. 3-and 4 functions the same as discussed for FIG. 1. Also in the apparatus magnifying camera according to FIGS. 3 and 4 the lighting unit 34 is located outside the viewing field of the sensor 8 if the object 4 would be a flat mirror.

As is shown in FIG. 2, in a folded condition the first and the second body portion abut against each other. In that condition the mirror 36 abuts a second outer surface 62 of the first body part 50 which second outer surface 62 lies opposite the lower outer surface 6 of the first body portion which, in use, is in contact with the object to be recorded. In this example, the portable magnifying camera is further provided with a button marked “−” and a button marked “+”. If the button “+” is operated the image of the object 4 is zoomed in on the display. If the button “−” is operated, a zooming out function will be executed. Furthermore, the apparatus is provided with a button 64 for adjusting the brightness of the image which is displayed on the display 10. Also the camera is provided with a power on/off button 66.

Based on FIGS. 5-11 an alternative embodiment of a camera according to the invention is described. In the figures corresponding elements are provided with the same reference numbers. FIGS. 9A, 9B show different features of the same embodiment.

The camera according to FIGS. 5-11 is also arranged to be positioned on an object to be recorded. The camera is provided with an outer lower surface 6 which is arranged to be in contact with the object if the camera is positioned on the object. Again the camera is provided with the light sensitive sensor for obtaining an image of at least a portion of the object, a display and processing means 12 for processing the image obtained by means of the sensor and for displaying at least a portion of the recorded image on the display 10.

The camera is further provided with a first body portion 100, a second body portion 102 and means for connecting and disconnecting the first body portion and the second body portion. The means 104 for connecting and disconnecting the first body portion 100 and second body portion 102 may for example comprise magnets. As schematically indicated, the first body portion 100 may be provided with a first magnet 104A wherein the second body portion 102 is provided with a second magnet 104B wherein in FIG. 5 the magnets generate such forces that the first body portion 100 and the second body portion 102 are forced towards each other but can be separated from each other by hand. FIG. 7 shows a bottom view of the second body portion 102 which is separated from the first body portion. As is shown in FIG. 7 the second body portion is provided with a lighting unit 14 which is provided, in this example, with four LED's 15. The four LED's 15 form a so called LED-strip. Furthermore the second body portion is provided with a light sensitive sensor 8, for example, a CCD or CMOS. Other types of sensors are however also possible. Furthermore, the second body portion is provided with a display 10. The first body portion 100 is arranged to be positioned on an object 4 to be recorded while the second body portion is connected with a first body portion. This situation is shown in FIG. 10 wherein the object to be recorded is a piece of paper. In use, the first body portion 100 provides a fixed distance between the second body portion 102 and the object 4 to be recorded as becomes clear from FIG. 10. In order to enable the recording the first body portion is provided with a side wall 106 surrounding an inner space 108 of the first body portion 100. Also the first body portion comprises a first opening 110 and a second opening 112 lying opposite to each other and providing visible access to the inner space 108. If the first body portion and the second body portion are connected together as is shown in FIG. 10, the second opening 112 faces the second body portion 102. Moreover, in use, in that case the first opening 110 faces the object 4 to be recorded such that the sensor 8 can capture an image of the object to be recorded via the second opening 112, the inner space 108, and the first opening 110. The first body portion comprises the outer lower surface 6 which is arranged to be in contact with the object 4 if the camera is positioned on the object. The outer lower surface 6 is made flat and is provided with rounded edges which are adjacent to the surrounding side wall 106 for easy sliding over the object 4. The first body portion 100 may, for example, be made from a plastic material. Other materials are also possible. For the sake of clarity it is indicated that the outer lower surface 6 comprises the first opening 110. As becomes clear from FIGS. 5, 6, 9 and 10, the display is inclined relative to the outer lower surface 6 if the second body portion is connected with the first body portion. This has as a result, as is shown in FIG. 10, that if the object to be recorded lies in a horizontal plane while the portable camera is positioned on a horizontal surface of the object, the display is facing the user which makes it easy for the user to see the content of which is displayed.

It is however also possible to disconnect the first body portion and the second body portion from each other so that the second body portion can be used as a hand-held camera. In that case, by means of the sensor 8, an image is captured from the object 4 which is shown on the display 10. This image may be processed by the processing means 12, for example for magnifying the image. At the same time the object 4 may be enlightened by means of the lighting unit 14 for improving the image of the object 4. If the second body portion 102 is hand-held such as shown in FIG. 11, it is also possible to display an image of the environment of the user, simply by panning the second body portion.

If on the other hand the first body portion and the second body portion are connected to each other, an image of the object 4 can be provided on the display 10 as is shown in FIG. 10. Also in that case by means of the processing means 12, the image can be processed, for example, for magnifying the image, adapting the resolution of the image, modifying the contrast or intensity of the image etc.

Because, as is shown in FIG. 10 the first body portion provides a fixed distance between the second body portion and the object to be recorded it is possible to provide an image of the object with a very high predetermined stable quality. Moreover other features of the camera according to the invention even further improve the quality of the image. As becomes clear from FIG. 6, the inner space 108 is completely surrounded by the side wall 106 wherein the opening 110 is in fact closed by the object 4 and the opening 112 is closed by the second body portion. This means that the portion of the object to be recorded is not enlightened by daylight. However the portion of the object to be recorded is enlightened by means of the lighting means 14. This has as an advantage that the enlightening of the object is of a predetermined level and nature so that the obtained image can be optimal. As discussed in relation with the embodiment according to FIGS. 1-4, it also holds in that case that the lighting unit 14 lies outside the viewing field of the camera which viewing field is obtained if the object 4 would be replaced by a perfect mirror (see FIG. 5). Again this viewing field is indicated by dotted lines 20, 22, 24, 26. This means that, as discussed above, if the object 4 would be glossy the camera 8 will not “see” via the glossy object the image of the lighting unit itself.

As is shown in FIG. 9, the sensor 8 is provided with an optical axis 116 which intersects the first opening 110 at least substantially in its center. Clearly in this way a good image can be obtained from the portion of the object which is visible through the first opening 110. Furthermore it holds that the at least one lighting unit 14 is positioned within a lighting unit plane 40 which is perpendicular to the optical axis 39 wherein the lighting unit plane 40 lies between the sensor 8 and the outer lower surface 6. Thus the camera has a relatively large distance to the lower surface for obtaining a larger image of the object wherein the lighting unit lies relatively close to the lower surface for providing a good illumination of the object. Because on the one hand the display 10 is tilted wherein the lighting unit and the sensor have a position relative to each other as discussed above it is at the same time realized that the second body portion is provided with a first side 120 and a second side 122 extending substantially parallel to each other wherein the second side comprises a display 10. In use, the first side faces the first body portion if the first body portion is connected to the second body portion. Also it holds that the second body portion has an overall shape of a flat and rectangular plate which enables easy hand-held use as is shown in FIG. 11. At the same time, as will be clear by now, the first body portion is provided with a first side 124 and a second side 126 extending at an angle α relative to each other wherein the first side comprises the first opening 110 and the second side 126 comprises the second opening 112. The first side of the second body portion faces the second side 122 of the first body portion if the first body portion is connected to the second body portion.

Thus the tilting of the display is realized by the first body portion so that the second body portion when disconnected from the first body portion can have a rectangular shape as discussed above.

As becomes clear from FIG. 9A, 9B (same embodiment with different features shown) the lighting unit 14 submits light rays 16 directly towards the opening 110. Because, as is shown in FIG. 9, the lighting unit 14 is positioned on the left-hand side, this may mean that the rectangular area 130 having a width d and a length l as is shown in FIG. 8 wherein this area is shown in shaded form, receives light having a smaller intensity than light received by other areas which are more close to the lighting unit 14. As a result of this, the shaded area 130 (laying in a virtual flat plane 32 through the opening and coinciding with the outer lower surface 6) may be directly illuminated by the lighting unit 14 with an intensity which is considerably lower than for example the intensity by which the rectangular area 132 (also laying in a virtual plane through the opening and coinciding with the outer lower surface 6) is directly illuminated as shown in FIG. 8. Thus the intensity of direct received light (see for example light ray 180 in FIG. 9B) in the area 130 is lower than the intensity of direct received light in the area 132 (see for example light ray 182 in FIG. 9B). This is due to the fact that the distance between the area 130 and the lighting unit is larger than the distance between the area 132 and the lighting unit. This is also caused by the fact that the direction of for example the light ray 180 relative to the area 130 differs from the direction of for example the light ray 182 relative to the area 132 (the light ray 180 has a larger angle z relative a normal of the virtual plane than the light ray 182). Thus the intensity wherein the area 130 is directly illuminated (for example measured in Lux) is lower than the intensity wherein the area 132 is directly illuminated. Thus without other ways of enlightening the intensity wherein the area 130 is enlightened may for example be 20% of the intensity wherein the area 132 is enlightened. In order to enlighten the portion of the object 4 which is visible through the opening 110 with a more equal light distribution, an inner surface 134 is provided with a curved portion 136. This curved portion extends upwards along the arrow as is shown in FIG. 9 and extends horizontally along the arrow h as shown in FIG. 8. This portion is arranged such that in use, it reflects some of the light emitted by the lighting unit towards the first opening if the first body portion is connected to the second body portion. In this way, an additional amount of light is submitted to the opening for providing in combination with the light which is submitted directly to the opening, a more evenly spread illumination of the object which is visible through the opening. In this example the area 130 may be illuminated by means of all light received (directly received light and light received after reflection(s)) with an intensity in the area 130 (again may be measured in Lux) which is 65% of the intensity by which the area 132 is illuminated by means of all light received (directly received light and light received after reflection(s)). In this example, the portion of the inner surface is arranged such that the portion of the light emitted by the lighting unit which is reflected by the portion of the inner surface is reflected in a diffused manner. For this, the portion 136 can have a well-known roughened structure.

It becomes clear from FIG. 9A, 9B that the distance between the lighting unit and the portion 136 of the curved inner surface is smaller than a distance between the sensor and the portion of the curved inner surface. Moreover, the portion 136 is arranged such that the portion of the light emitted by the lighting unit which is reflected by the portion 136 of the inner surface is reflected towards an area 130 of the first opening having a larger distance to the lighting unit than other areas 132 of the first opening.

This reflection towards the area 130 may be directly as is shown by light ray 200 of may be indirectly by means of a reflection on another portion 202 of the inner surface as is shown by light ray 204 (see FIG. 9B).

More particularly it holds that the portion of the inner surface is arranged such that the portion of the light emitted by the lighting unit which is reflected by the portion of the inner surface is reflected towards an area 130 of the first opening having a larger distance to the lighting unit than each other area of the first opening. The above may also hold for other areas such as shown in FIG. 9B. In FIG. 9B the area 150 of the first opening having a larger distance to the lighting unit than other areas forms a first halve of the first opening and the other areas form a second halve 152 of the first opening wherein the first halve and the second halve in combination form the first opening.

It further holds that the portion of the inner surface is arranged such that the portion of the light emitted by the lighting unit which is reflected by the portion of the inner surface has a larger intensity on the position of the first opening having a larger distance to the lighting unit than other positions of the first opening. This position may, for example, lie within the area 130 whereas the other positions lie outside this area.

It further holds that the portion 136 is arranged such that the portion of the light emitted by the lighting unit which is reflected by the portion of the inner surface increases the intensity of the light more in a first area 130 of the first opening than in a second area 132 of the first opening wherein the intensity of the light in the first area as a result of the light which is directly received from the lighting unit in the first area 130 is lower than the intensity of the light in the second area as a result of the light which is directly received from the lighting unit in the second area 132. This also holds for other selections of areas such as shown in FIG. 9B. There it holds that the portion 136 is arranged such that the portion of the light emitted by the lighting unit which is reflected by the portion of the inner surface increases the intensity of the light more in a first area 150 of the first opening than in a second area 152 of the first opening wherein the intensity of the light in the first area as a result of the light which is directly received from the lighting unit in the first area 150 is lower than the intensity of the light in the second area as a result of the light which is directly received from the lighting unit in the second area 152. In this case the first area and the second are each form a halve of the first opening and wherein the first area and the second area in combination form the first opening.

Thereby it is clear that the light reflected by the portion 136 compensates intensity differences between different areas as a result of the direct lighting of these areas by means of the lighting unit 14. In other words it holds that the light rays emitted by the lighting unit which directly illuminates a plane laying in the first opening provide a first distribution of light intensity in the plane 32 which is not uniform spread over this plane wherein the portion of the inner surface is arranged such that the portion of the light emitted by the lighting unit which is reflected by the portion of the inner surface provides in combination with the light rays which are directly received in the plane a total distribution of light intensity in the plane 32 which is more uniform spread over this plane than the first distribution.

This feature of the invention may be further described as follows. The first opening is provided with a first edge 150 and a second edge 152 laying opposite to each other. In fact the first opening is further provided with two opposites edges 154, 156 wherein the edges 150-156 provide the first opening with a rectangular shape. The lighting unit directly illuminates the plane 32 through the first opening adjacent the first edge 150 with an intensity which is higher than the intensity whereby the plane adjacent the second edge 152 is directly illuminated by the lighting unit. Furthermore the portion of the inner surface is arranged such that the portion of the light emitted by the lighting unit which is reflected by the portion of the inner surface illuminates the plane adjacent the first edge 150 with an intensity which is lower than the intensity by which the plane adjacent the second edge 152 is illuminated by the lighting unit via the portion of the inner surface. The portion of the inner surface is arranged such that the portion of the light emitted by the lighting unit which is reflected by the portion of the inner surface is mainly reflected in predetermined directions wherein each of the predetermined directions p (p1, p2) and the outer lower surface enclose an angle γ1, γ2 which is smaller than 90°, preferably smaller than 60° and more preferable smaller than 45° (see FIG. 9A).

The example is in no matter limited to the disclosed embodiments. Clearly the angle α may have other values as shown in FIG. 9A. For example the angle α may be around 40° or even 45°. In this example the lighting unit is positioned outside the viewing field defined by dotted lines 20, 22, 24, 26. It is however also possible that the lighting unit is placed within the viewing field defined by these lights. Of course in that case glare may occur but the camera has still the advantage that the first body portion and the second body portion can be separated from each other so that the second body portion can be used as a hand-held camera.

Also the portable camera may be provided with zoom buttons 140 (FIG. 5) and mode buttons 142. By means of the zoom buttons the amount of magnification (zoom-in and zoom-out) may be varied. By means of the mode buttons it is for example possible to, in combination with the zoom buttons 114 to vary the light intensity of the lighting unit, the contrast of the displayed image, the intensity of the displayed image, etc. In this example the first and second body portion are connected to each other by means of magnets. Other coupling means are possible such as mechanical coupling means for example a bayonet closure. Such variations all fall within the scope of the invention.

In this example the portable magnifying cameras are arranged for recording streaming video of the object 4 and displaying same on the display 10. This means that if the object is moved relative to the camera, a moving image of the object will be displayed on the display 10. It is however also possible that photos of the object 4 are made and displayed on the display 10.

Furthermore, according to the invention it is possible that the processing means are arranged for recognizing words on the object and converting recognized words into spoken text. The spoken text can be outputted to, for example, a head phone which is connected to the camera. Additionally or alternatively, a Braille display may be operated by means of the camera if the processing means are arranged to recognize words on the object. In accordance with the invention it is also possible that the portable camera is not provided with a display 10. In that case, the processing means 12 may be arranged for converting recognized text on the object into speech as indicated above. Such variations all fall within the scope of the invention.

1. A portable camera for recording and displaying an image of an object such as printed paper, wherein the camera is arranged to be positioned on an object to be recorded wherein the camera is provided with an outer lower surface which is arranged to be in contact with the object if the camera is positioned on the object, a light sensitive sensor for obtaining an image of at least a portion of the object, a display and processing means for processing the image obtained by means of the sensor and for displaying at least a portion of the recorded image on the display, in possible a magnified form, wherein the camera is provided with at least one lighting unit for lighting the object to be recorded when the camera is positioned on the object, the camera is arranged such that light rays of the at least one lighting unit which are, in use, submitted to the object are directly submitted to the object, wherein the lighting unit is arranged within the camera such that if the object which is recorded would be a flat mirror whereon the camera is positioned for recording the reflective surface of the flat mirror, the lighting unit is located outside a viewing field of the sensor which viewing field is formed in combination with the flat mirror.

2. The portable camera according to claim 1, having an outer lower surface, wherein the outer lower surface extends in a virtual flat plane wherein, in use, a lighting unit submits light to a virtual flat plane and/or in that a flat mirror coincides with a virtual flat plane extending through the outer lower surface wherein it holds that the lighting unit is located outside a viewing field of a sensor which viewing field is formed in combination with the last said virtual flat plane if the virtual flat plane would be a flat mirror and/or that the flat mirror is sufficiently large so that it extends through the full viewing field of the sensor.

3. The portable camera according to claim 1, wherein the camera is arranged such that the light rays of the lighting unit are submitted directly to the object by means of specular reflection only, if there would be any reflection and/or in that the camera is arranged such that the light rays of the lighting unit are submitted directly to the object by means of specular transmission through a medium only, if there would be any transmission through a medium.

4. The portable camera according to claim 1 wherein the outer lower surface is flat.

5. The portable camera according to claim 1 wherein the flat mirror is positioned against the outer lower surface.

6. The portable camera according to claim 1 wherein the camera is provided with at least one light mirror for folding up the light path which extends from the at least one lighting unit to the flat mirror.

7. The portable camera according to claim 2, wherein the sensor is provided with an optical axis wherein, in use, the at least one lighting unit is positioned within a lighting unit plane which is perpendicular to the optical axes wherein the lighting unit plane lies between the sensor and the virtual flat plane.

8. The portable camera according to claim 7, wherein in use the light mirror lies in a mirror plane which is angled relative to the light plane.

9. The portable camera according to claim 8, wherein the light mirror lies between the light plane and a sensor plane extending through an outer surface of the sensor which receives light for recording the image, wherein the sensor plane is perpendicular to the optical axes.

10. The portable camera according to claim 1 wherein the camera is provided with a first body portion, a second body portion and a hinge means for connecting the first body portion and the second body portion together wherein the first body portion can move relative to the second body between a folded condition and an unfolded working condition for use of the camera, wherein the second body portion is provided with the sensor and the first body portion is provided with the lighting unit and wherein in the unfolded condition there is a distance between the first body portion and second body portion.

11. The portable camera according to claim 10, wherein the first body portion is arranged to be positioned on the object to be recorded.

12. The portable camera according to claim 11, wherein the first body portion comprises the outer lower surface.

13. The portable camera according to claim 10, wherein the lighting unit is arranged to submit light in a direction of the second body portion if the camera is in the unfolded condition.

14. The portable camera according to claim 10, wherein if the camera is in the unfolded condition, in use, the second body portion extends above the first body portion.

15. The portable camera according to claim 10, wherein the light mirror is formed by an outer surface of the second body portion wherein, if the camera is in the unfolded condition, in use, the light mirror faces downwardly.

16. The portable camera according to claim 10, wherein the second body portion is provided with the display wherein, the display and the light mirror lie on opposite sides of the second body portion.

17. The portable camera according to claim 10, wherein in the folded condition the first and the second body portion abut against each other.

18. The portable camera according to claim 10, wherein in the folded condition the light mirror abuts a second outer surface of the first body portion which lies opposite the outer lower surface of the first body portion which, in use, is in contact with the object to be recorded.

19. The portable camera according to claim 10, wherein the first body portion and the second body portion each have an overall shape of a flat rectangular plate.

20. The portable camera according to claim 19, wherein the first body portion is provided with an opening for recording the object.

21. The portable camera according to claim 1 wherein the camera is provided with a first body portion, a second body portion and a means for connecting and disconnecting the first body portion and the second body portion, wherein the second body portion is provided with the lighting unit, the sensor and the display and wherein the first body portion is arranged to be positioned on the object to be recorded while the second body portion is connected with the first body portion such that, in use, the first body portion provides a fixed distance between the second body portion and the object to be recorded wherein the first body portion is provided with a side wall surrounding an inner space of the first body portion and a first and second opening lying opposite to each other and providing visible access to the inner space wherein if the first body portion and the second body portion are connected together the second opening faces the second body portion and the first opening, in use, faces the object to be recorded such that the sensor can capture an image of the object to be recorded via the second opening, the space and the first opening.

22. The portable camera according to claim 21, wherein the first body portion comprises the outer lower surface.

23. The portable camera according to claim 22, wherein the outer lower surface comprises the first opening.

24. The portable camera according to claim 22 wherein the display is inclined relative to the outer lower surface if the second body portion is connected with the first body portion.

25. The portable camera according to claim 23 wherein if the first body portion is connected to the second body portion a distance between the lighting unit and the outer lower surface is smaller than the a distance between the sensor and the outer lower surface.

26. The portable camera according to claim 1 wherein the sensor is provided with an optical axis wherein, in use, the at least one lighting unit is positioned within a lighting unit plane which is perpendicular to the optical axes wherein the lighting unit plane lies between the sensor and the outer lower surface and/or in that the sensor is provided with an optical axis which intersects a flat plane through the first opening in substantially a centre of the first opening.

27. The portable camera according to claim 21, wherein the second body portion is provided with a first and second side extending substantially parallel to each other wherein the second side comprises the display and the first side faces the first body portion if the first body portion is connected to the second body portion and/or in that the second body portion has an overall shape of a flat rectangular plate.

28. The portable camera according to claim 21, wherein the first body portion is provided with a first and second side extending at an angle relative to each other wherein the first side comprises the first opening and the second side comprises the second opening wherein the first side of the second body portion faces the second side of the first body portion if the first body portion is connected to the second body portion.

29. The portable camera according to claim 21, wherein a portion of an inner surface of the first body portion is curved such that, in use, it reflects some of the light emitted by the lighting unit towards the first opening if the first body portion is connected to the second body portion.

30. The portable camera according to claim 29, wherein the portion of the inner surface is arranged such that the portion of the light emitted by the lighting unit which is reflected by the portion of the inner surface is reflected in a diffused manner.

31. The portable camera according to claim 29, wherein a distance between the lighting unit and the portion of the curved inner surface is smaller than a distance between the sensor and the portion of the curved inner surface.

32. The portable camera according to claim 29, wherein the portion of the inner surface is arranged such that the portion of the light emitted by the lighting unit which is reflected by the portion of the inner surface is reflected towards an area of the first opening having a larger distance to the lighting unit than other areas of the first opening, in that the portion of the inner surface is arranged such that the portion of the light emitted by the lighting unit which is reflected by the portion of the inner surface is reflected towards an area of the first opening having a larger distance to the lighting unit than each other areas of the first opening wherein in particular the area of the first opening having a larger distance to the lighting unit than other areas forms a first halve of the first opening and the other areas form a second halve of the first opening wherein the first halve and the second halve in combination form the first opening.

33. The portable camera according to claim 29, wherein the light rays emitted by the lighting unit which directly illuminates a plane laying in the first opening provide a first distribution of light intensity in the plane which is not uniform spread over this plane wherein the portion of the inner surface is arranged such that the portion of the light emitted by the lighting unit which is reflected by the portion of the inner surface provides in combination with the light rays which are directly received in the plane a total distribution of light intensity in the plane which is more uniform spread over this plane than the first distribution.

34. The portable camera according to claim 29, wherein the first opening is provided with a first edge and a second edge laying opposite to each other wherein the lighting unit directly illuminates a plane through the first opening adjacent the first edge with an intensity which is higher than the intensity by which the plane adjacent the second edge is directly illuminated by the lighting unit and wherein the portion of the inner surface is arranged such that the portion of the light emitted by the lighting unit which is reflected by the portion of the inner surface illuminates the plane adjacent the first edge with an intensity which is lower than the intensity by which the plane adjacent the second edge is illuminated by the lighting unit via the portion of the inner surface.

35. The portable camera according to claim 29, wherein the portion of the inner surface is arranged such that the portion of the light emitted by the lighting unit which is reflected by the portion of the inner surface has a larger intensity on a position laying in the first opening having a larger distance to the lighting unit than other positions laying in the first opening.

36. The portable camera according to claim 29, wherein the portion of the inner surface is arranged such that the portion of the light emitted by the lighting unit which is reflected by the portion of the inner surface increases the intensity of the light more in a first area of the first opening than in a second area of the first opening wherein the intensity of the light in the first area as a result of the light which is directly received from the lighting unit in the first area is lower than the intensity of the light in the second area as a result of the light which is directly received from the lighting unit in the second area, wherein in particular the first area and the second are each form a half of the first opening and wherein the first area and the second area in combination form the first opening.

37. The portable camera according to claim 29, wherein the portion of the inner surface is arranged such that the portion of the light emitted by the lighting unit which is reflected by the portion of the inner surface is mainly reflected in predetermined directions wherein each of the predetermined directions and a normal of the outer lower surface enclose an angle which is smaller than 90 degrees.

38. The portable camera according to claim 1 wherein the processing means is arranged for extracting text from the object and for converting extracted text into speech.

39. The portable camera according to claim 1 wherein the processing means is arranged for selective magnification of the image to be displayed on the display.

40. A portable camera for recording an image of an object such as printed paper wherein the camera is arranged to be positioned on an object to be recorded wherein the cameras is provided with an outer lower surface which is arranged to be in contact with the object if the camera is positioned on the object, a light sensitive sensor for obtaining an in image of at least a portion of the object, and processing means for processing the image obtained by means of the sensor, wherein the camera is provided with at least one lighting unit for lighting the object to be recorded when the camera is positioned on the object, characterized in that, the camera is arranged such that light rays of the at least one lighting unit which are, in use, submitted to the object are directly submitted to the object, wherein the lighting unit is arranged within the camera such that if the object which is recorded would be a flat mirror whereon the camera is positioned for recording the flat mirror, the lighting unit is located outside a viewing field of the sensor which viewing field is formed in combination with the flat mirror.

41. (canceled)

42. A portable camera for recording and displaying an image of an object such as printed paper, wherein the camera is arranged to be positioned on an object to be recorded wherein the cameras is provided with an outer lower surface which is arranged to be in contact with the object if the camera is positioned on the object, a light sensitive sensor for obtaining an image of at least a portion of the object, a display and processing means for processing the image obtained by means of the sensor and for displaying at least a portion of the recorded image on the display, in possible a magnified form, wherein the camera is provided with at least one lighting unit for lighting the object to be recorded when the camera is positioned on the object, characterized in that, the camera is provided with a first body portion, a second body portion and a means for connecting and disconnecting the first body portion and the second body portion, wherein the second body portion is provided with the lighting unit, the sensor and the display and wherein the first body portion is arranged to be positioned on the object to be recorded while the second body portion is connected with the first body portion such that, in use, the first body portion provides a fixed distance between the second body portion and the object to be recorded wherein the first body portion is provided with a side wall surrounding an inner space of the first body portion and a first and second opening lying opposite to each other and each providing visible access to the inner space (if the first body portion and the second body portion are disconnected from each other) wherein if the first body portion and the second body portion are connected together the second opening faces the second body portion and the first opening, in use, faces the object to be recorded such that the sensor can capture an image of the object to be recorded via the second opening, the space and the first opening.

43. The portable camera according to claim 42, wherein the first body portion comprises the outer lower surface.

44. The portable camera according to claim 43, wherein the outer lower surface comprises the first opening.

45. The portable camera according to claim 43 wherein the display is inclined relative to the outer lower surface if the second body portion is connected with the first body portion.

46. The portable camera according to claim 44 wherein if the first body portion is connected to the second body portion a distance between the lighting unit and the outer lower surface is smaller than the a distance between the sensor and the outer lower surface.

47. The portable camera according to claim 42, wherein the sensor is provided with an optical axis wherein, in use, the at least one lighting unit is positioned within a lighting unit plane which is perpendicular to the optical axes wherein the lighting unit plane lies between the sensor and the outer lower surface.

48. The portable camera according to claim 42, wherein the second body portion is provided with a first and second side extending substantially parallel to each other wherein the second side comprises the display and the first side faces the first body portion if the first body portion is connected to the second body portion and/or in that the second body portion has an overall shape of a flat rectangular plate.

49. The portable camera according to claim 42, wherein the first body portion is provided with a first and second side extending at an angle relative to each other wherein the first side comprises the first opening and the second side comprises the second opening wherein the first side of the second body portion faces the second side of the first body portion if the first body portion is connected to the second body portion.

50. The portable camera according to claim 42, wherein a portion of an inner surface of the first body portion is curved such that, in use, it reflects some of the light emitted by the lighting unit towards the first opening if the first body portion is connected to the second body portion.

51. The portable camera according to claim 50, wherein the portion of the inner surface is arranged such that the portion of the light emitted by the lighting unit which is reflected by the portion of the inner surface is reflected in a diffused manner.

52. The portable camera according to claim 50, wherein a distance between the lighting unit and the portion of the curved inner surface is smaller than a distance between the sensor and the portion of the curved inner surface.

53. The portable camera according to claim 50 wherein the portion of the inner surface is arranged such that the portion of the light emitted by the lighting unit which is reflected by the portion of the inner surface is reflected towards an area of the first opening having a larger distance to the lighting unit than other areas of the first opening, more particularly in that the portion of the inner surface is arranged such that the portion of the light emitted by the lighting unit which is reflected by the portion of the inner surface is reflected towards an area of the first opening having a larger distance to the lighting unit than each other areas of the first opening wherein in particular the area of the first opening having a larger distance to the lighting unit than other areas forms a first halve of the first opening and the other areas form a second halve of the first opening wherein the first halve and the second halve in combination form the first opening.

54. The portable camera according to claim 50, wherein the light rays emitted by the lighting unit which directly illuminates a plane laying in the first opening provide a first distribution of light intensity in the plane which is not uniform spread over this plane wherein the portion of the inner surface is arranged such that the portion of the light emitted by the lighting unit which is reflected by the portion of the inner surface provides in combination with the light rays which are directly received in the plane a total distribution of light intensity in the plane which is more uniform spread over this plane than the first distribution.

55. The portable camera according to claim 50, wherein the first opening is provided with a first edge and a second edge laying opposite to each other wherein the lighting unit directly illuminates a plane through the first opening adjacent the first edge with an intensity which is higher than the intensity by which the plane adjacent the second edge is directly illuminated by the lighting unit and wherein the portion of the inner surface is arranged such that the portion of the light emitted by the lighting unit which is reflected by the portion of the inner surface illuminates the plane adjacent the first edge with an intensity which is lower than the intensity by which the plane adjacent the second edge is illuminated by the lighting unit via the portion of the inner surface.

56. The portable camera according to claim 50, wherein the portion of the inner surface is arranged such that the portion of the light emitted by the lighting unit which is reflected by the portion of the inner surface has a larger intensity on a position laying in the first opening having a larger distance to the lighting unit than other positions laying in the first opening.

57. The portable camera according to claim 50, wherein the portion of the inner surface is arranged such that the portion of the light emitted by the lighting unit which is reflected by the portion of the inner surface increases the intensity of the light more in a first area of the first opening than in a second area of the first opening wherein the intensity of the light in the first area as a result of the light which is directly received from the lighting unit in the first area is lower than the intensity of the light in the second area as a result of the light which is directly received from the lighting unit in the second area wherein in particular the first area and the second are each form a half of the first opening and wherein the first area and the second area in combination form the first opening.

58. The portable camera according to claim 50, wherein the portion of the inner surface is arranged such that the portion of the light emitted by the lighting unit which is reflected by the portion of the inner surface is mainly reflected in predetermined directions wherein each of the predetermined directions and a normal of the outer lower surface enclose an angle which is smaller than 90 degrees.

59. The portable camera of claim 1 wherein light rays of the at least one lighting unit which are, in use, submitted to the object are directly submitted to the object via a mirror and/or a lens.

60. The portable camera according to claim 19, wherein the first body portion has the same overall shape and size as the second body portion.

61. The portable camera according to claim 37, wherein each of the predetermined directions and a normal of the outer lower surface enclose an angle smaller than 60 degrees.

62. The portable camera according to claim 37, wherein each of the predetermined directions and a normal of the outer lower surface enclose an angle smaller than 45 degrees.

63. The portable camera of claim 40 wherein light rays of the at least one lighting unit which are, in use, submitted to the object are directly submitted to the object via a mirror and/or a lens.

64. The portable camera according to claim 58, wherein each of the predetermined directions and a normal of the outer lower surface enclose an angle smaller than 60 degrees.

65. The portable camera according to claim 58, wherein each of the predetermined directions and a normal of the outer lower surface enclose an angle smaller than 45 degrees.
